(19) United States
(12) Patent Application Publication
(10) Pub. No.: US 2025/0078692 A1
(43) Pub. Date: Mar. 6, 2025

(54) TWO-PIECE, FLAT-PACKING, QUICK-DEPLOYING POINT-OF-PURCHASE DISPLAY

(71) Applicant: Great Northern Corporation, Appleton, WI (US)

(72) Inventor: Ryan Schramkowski, Waukesha, WI (US)

(73) Assignee: Great Northern Corporation, Appleton, WI (US)

(21) Appl. No.: 18/827,214

(22) Filed: Sep. 6, 2024

Related U.S. Application Data
(60) Provisional application No. 63/536,755, filed on Sep. 6, 2023.

(51) Int. Cl. G09F 15/00

(52) U.S. Cl. CPC G09F 15/0062

(57) ABSTRACT

A two-piece collapsible, pop-up display having an outer shell fabricated from a single piece of sheet material having an inside surface and an outside surface, and an insert fabricated from a single piece of sheet material, wherein the insert is attached to the inside surface of the outer shell. The outer shell and the insert having cooperating/corresponding pre-perforated apertures and shelf panels, respectively. The outer shell and attached insert are movable between a first, flat position and a second, deployed position in which the outer shell and insert cooperate to define one or more shelves for displaying product for sale.

### CROSS-REFERENCE TO RELATED APPLICATIONS

Priority is hereby claimed to provisional patent application Ser. No. 63/536,755, filed Sep. 6, 2023, which is incorporated herein by reference.

### BACKGROUND

Point-of-purchase displays made of corrugated paper, chip board, and other disposable materials are well known. See, for example, U.S. Pat. No. 9,969,523, issued May 15, 2018, to Ayerst, and U.S. Pat. No. 8,740,054, issued Jun. 3, 2014, to Pinkstone, among several others. These displays are temporary and typically include attractive printing and other useful information to persuade buyers to purchase the item displayed.

The widely used term “POP” display is itself a play on words. In one sense of the phrase, the term “POP” display refers to a “point-of-purchase” display. Point-of-purchase displays are printed or digital displays placed near advertised items, in the store itself, adjacent to the goods being promoted for sale. Unlike marketing campaigns designed to get customers into the store, POP displays focus on customers' in-store experience by bringing attention to particular brands or special offers. In another sense of the phrase “POP” can refer to a “pop up” display-a display rack that ships in a disassembled or semi-disassembled condition and can be “popped” open (i.e., deployed) to hold and display product for sale.

### SUMMARY OF THE INVENTION

Disclosed herein is a two-piece, collapsible, pop-up display. The two pieces are a shell and a cooperating insert. The display ships flat and can be deployed for holding and displaying goods for sale in less than 10 seconds. The two pieces are a shell, and an insert that cooperate to define the shelves of the pop-up display. The outer shell is fabricated from a single piece of sheet material having an inside surface and an outside surface. The outer shell has contiguous front and rear panels, left and right panels, and at least one bottom panel.

In at least one of these panels, preferably in the front panel, is defined at least one pre-perforated aperture. The pre-perforated aperture is convertible from a first, closed position and a second, open position. The entire pop-up display ships with the per-perforated aperture(s) in the closed position. The aperture(s) is then converted to the open position when the display is placed in store. In the first, closed position, the aperture is covered by an integral, pre-perforated upper shelf portion and an integral, pre-perforated lower tab portion. The two portions are divided substantially horizontally with the shelf portion above the tab portion.

The shelf portion is attached to a corresponding shelf portion on the insert, described in the following paragraphs. In cooperation with the shelf panel of the insert, when the shelf portion of the shell is pushed inward (into the interior of the shell), it and the attached shelf panel of the insert define a horizontal shelf onto which product can be placed for display.

Inside the shell is disposed an insert that cooperates with the shell to define one or more shelves. Like the shell, the insert is fabricated from a single piece of sheet material. The insert comprises a front panel, left and right panels, and a bottom support panel that are dimensioned and configured to match the interior dimensions and configuration of the shell.

The insert includes at least one pre-perforated shelf panel. The insert has the same number of shelf panels as the shell has apertures. The pre-perforated shelf panels of the insert are disposed in registration with the pre-perforated aperture(s) when the insert is disposed inside the shell. The insert and the shell are fastened to one another between the inside surface of the shelf portion of the shell and the shelf panel of the insert. In this fashion, when the shelf portion of the shell is pushed inward (into the interior of the shell), the attached shelf panel of the insert moves with it and the two cooperate to form a shelf in the interior of the shell and accessible through the aperture in the shell. Good are then loaded onto the shelf for display.

### BRIEF DESCRIPTION OF DRAWINGS

FIG. 1 is a front elevational view of the outside surface of the unassembled shell (100) of the POP display disclosed herein. (The dimensions are exemplary and non-limiting.)

FIG. 2 is a front elevational view of the unassembled insert (200) of the POP display disclosed herein.

FIG. 3 is a front elevational photograph of the POP display disclosed herein, assembled, deployed, and ready to be loaded with goods for sale.

FIG. 4 is a left-side elevational photograph of the POP display shown in FIG. 3.

### DETAILED DESCRIPTION OF THE INVENTION

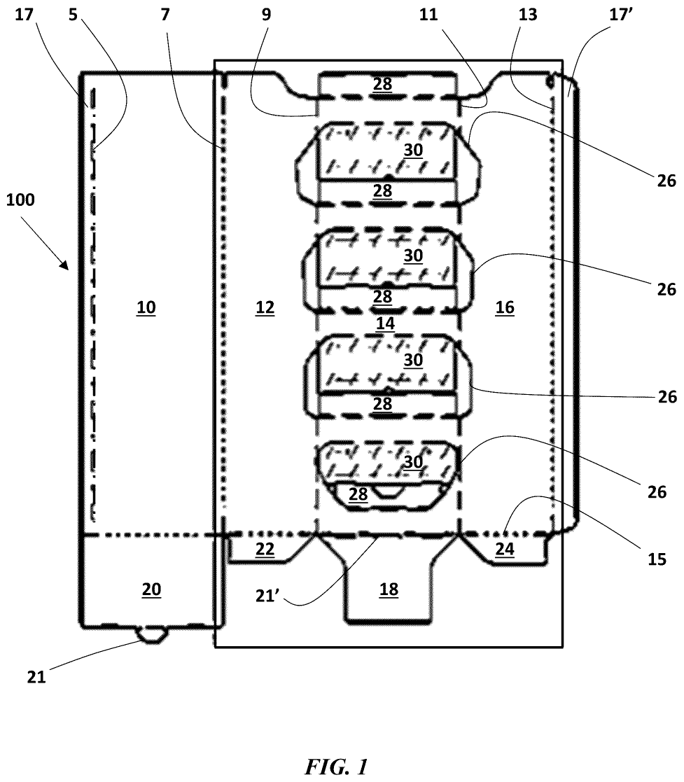

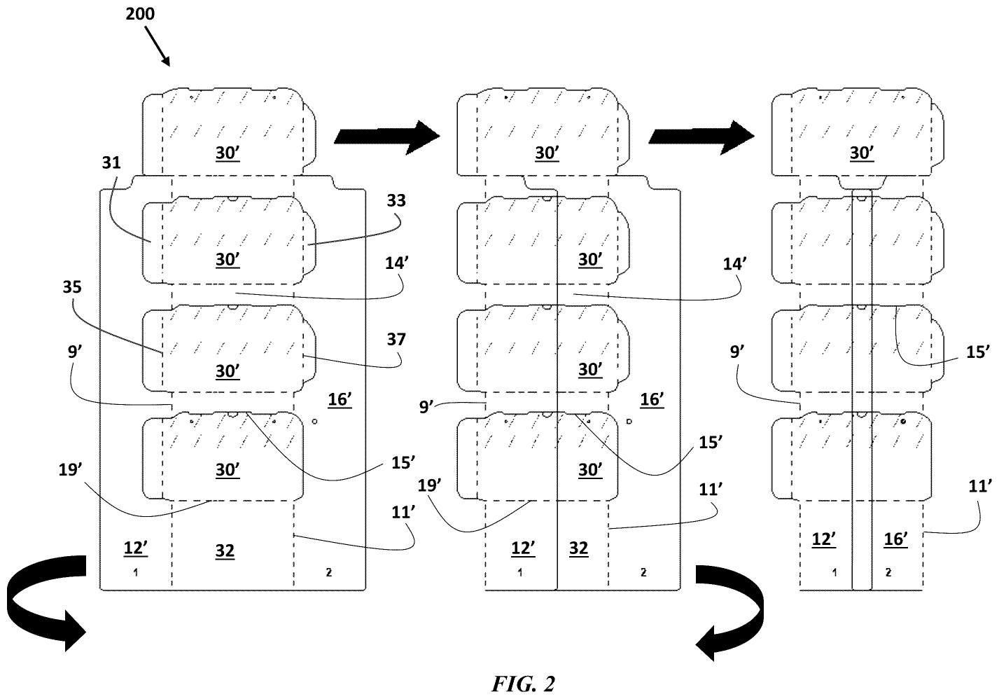

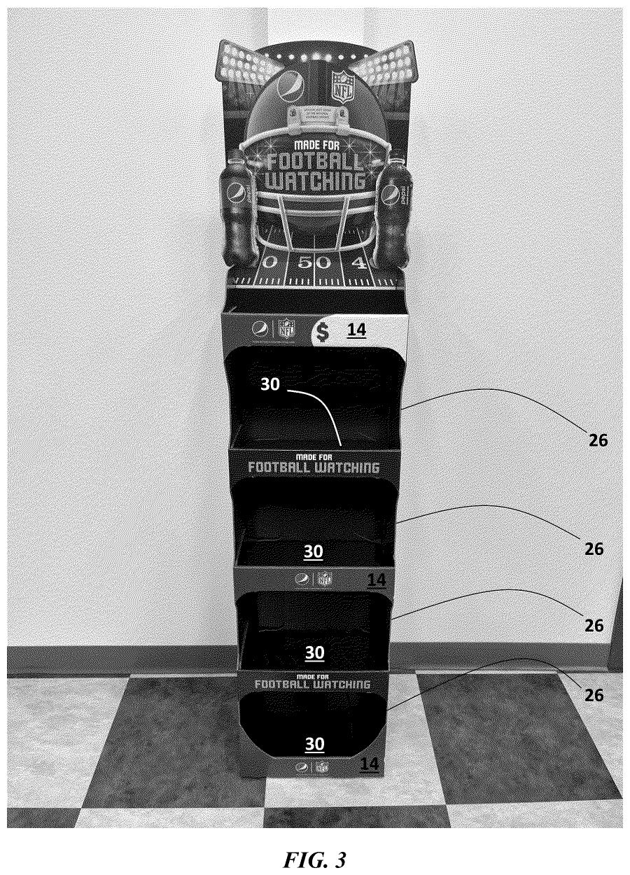

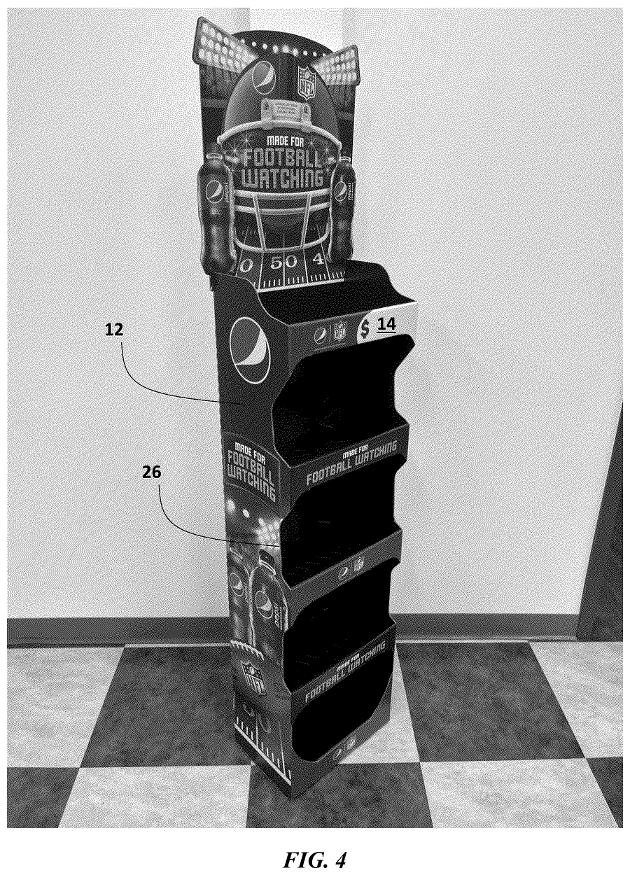

Disclosed herein is a two-part pop-up display that can be shipped flat and deployed in a matter of second by just one person. The deployed pop-up display is shown in front elevation view in FIG. 3, and in a left-side perspective view in FIG. 4. Its construction, though, is shown in FIGS. 1 and 2. FIG. 1 depict the outer shell 100; FIG. 2 depicts the interest 200, which fits inside the outshell 100 and cooperates with the outer shell to define the shelves of the display when it is deployed.

Referring now to FIG. 1, the figure depicts an outer shell 100, disassembled and laid flat. The shell 100 is preferably made of a single piece of suitably stiff sheet material, such as cardboard, corrugated paper, particle board, foam board, and the like. The outer shell comprises a rear panel 10 contiguous with a left side panel 12, a front panel 14, a right side panel 16 and cooperating tabs 17 and 17′. Across the bottom of the shell are an outer bottom panel 20 contiguous with the rear panel 10, a tab 22 contiguous with the left-side panel 12, an inner bottom panel 18 contiguous with the front panel 14, and a tab 24 contiguous with the right side pane 16. A fold line 15 (oriented horizontally in FIG. 1) delimits the lower end of panels 10, 12, 14, and 16, from panels 20, 22, 18, and 24. Vertically, the rear panel 10 is further delimited by the fold lines 5 and 7. The left side panel 12 is further delimited by fold lines 7 and 9. The front panel 14 is further delimited by fold lines 9 and 11. The right side panel 16 is further delimited by fold lines 11 and 13. Fold lines 5 and 13 define the inner edges of the tabs 17 and 17′, respectively.

To form a housing, panels 10 and 12 and tab 17 are folded rearward along fold lines 5, 7, and 9. Likewise, panel 16 and tab 17′ are folded rearward along fold lines 11 and 13 so that tabs 17 and 17′ are juxtaposed with one another (which would be at the rear, right corner of the housing, as depicted in FIG. 1). Tabs 17 and 17′ are then adhered to one another (permanently or reversibly) using any fastener now known in the art or developed in the future. Typical fasteners include glue, staples, hook-and-loop-type fasteners (such as Velcro®-brand hook and loop fasteners), snaps, and the like. Even when the two tabs 17 and 17′ are fastened to one another, the shell 100 can be made to lay flat by skewing the housing along the fold lines. (For example, by skewing the housing along fold lines 7 and 11 after tabs 17 and 17′ are connected.)

The front panel 14 of shell 100 (and optionally extending into left side panel 12 and right side panel 16) has at least one aperture 26 defined therein. As shown in the figure, there are four apertures 26. This is only by way of example. The shell may have as few as one (1) aperture and as many as the size and structural rigidity of the material from which the shell is made will permit. The aperture may be entirely within front panel 14 or extend into one or both of panels 12 and 16. The apertures 26 are formed via pre-perforating the shell 100. The interior panel circumscribed by the pre-perforation (and which occludes the apertures prior to the pop-up display being deployed) is left attached at the top and bottom of the aperture 26 and is further pre-perforated into a shelf portion 31 (see FIG. 2) (which remains attached to front panel 14 at its top edge as shown in FIG. 1) and a retaining tab 28 (which remains attached to the front panel 14 at its bottom edge as shown in FIG. 1). To open the aperture 26, the shelf portion 31 is pushed inward and upward to define (in part) a shelf in the interior of the housing formed by the shell 100 when it is deployed; the retaining tab 28 is pushed inward and downward and is doubled back upon the inside surface (not shown) of front panel 14. The inside surface of each shelf portion 31 is affixed to a cooperating shelf panel 30 of an insert 200 (see FIG. 2) which fits inside the housing formed by the shell 100.

FIG. 2 depicts an insert 200 that is formed of a single piece of suitably stiff sheet material, such as cardboard, corrugated paper, particle board, foam board, and the like. The insert 200 comprises a left side panel 12′ contiguous with a front panel 14′ and a right-side panel 16′. The left side panel 12′ is delimited vertically by fold line 9′. The front panel 14′ is delimited vertically by fold lines 9′ and 11′. The right-side panel 16′ is delimited vertically by fold line 11′.

At least one shelf panel 30′ is defined by perforations in the front panel 14′ and optionally parts of the left side panel 12′ and right side panel 16′. There are as many shelf panels 30′ in the insert 200 as there are shelf portions 31 in the shell 100. The top edge of each shelf panel 30′ is attached to the front panel 14′ via fold line 15′. The lower-most portion of the front panel 14′ defines a bottom support panel 32. The bottom support panel 32 is delimited from the lowest shelf panel 30′ by fold line 19′. When the insert 200 is placed inside the shell 100 and the pop-up display is deployed, the lower edge of bottom support panel 32 is flush with the lowest edge of the shell 100. When the pop-up display is flat, bottom support panel 32 extends beyond the lowest edge of the shell 100.

The insert 200 is joined to the shell 100 by folding left side panel 12′ inward, toward front panel 14′ as shown in the left-hand panel in FIG. 2. Thus in the center panel of FIG. 2, the reverse side of panel 12′ is seen. Likewise, the right side panel 16′ is folded inward, toward the front panel 14′ as shown in the middle panel of FIG. 2. The resulting configuration of the insert 200 is then as shown in the right-hand panel of FIG. 2, in which the reverse side of both panels 12′ and 16′ is seen. In this configuration, the surface of panels 12′ and 16′ as shown in the right-hand view in FIG. 2 are attached to the inner surface of the rear panel 10 of the shell 100, with the shelf panels 30′ in registration with the apertures 26 of the shell 100.

Referring now to both FIGS. 1 and 2, with the insert 200 attached to the interior surface of the rear panel 10 of the shell 100, the tabs 17 and 17′ of the shell are fastened to each other as described above. Once the shell is closed upon itself with tabs 17 and 17′ and the bottom surface closed via panels 20, 22, 18, and 24, the insert 200 is disposed in the interior of the housing defined by the shell, and attached to the back, inside wall of the housing. The inside surface of each shelf panel 30 of the shell 100 (see FIG. 1) is then attached to the corresponding facing surface of shelf panel 30′ of the insert, face-to-face. This can be accomplished using any fastener now known or developed in the future. As noted above, typical fasteners include glue, staples, hook-and-loop-type fasteners (such as Velcro®-brand hook and loop fasteners), snaps, and the like. With the insert 200 attached to the back panel 10 of the shell 200 through panels 12′ and 16′, and the shelf panels 30′ of the insert 200 attached to the shelf portions 31 of the shell 100, the entire construction can still be folded flat by skewing the shell 100 along the fold lines at opposite corners of the shell, e.g., along fold lines 7 (rear left corner) and 11 (front right corner).

To deploy the pop-up display from its first, flat position, the shell 100 is simply skewed in the opposite direction to a second position in which the shell defines a three-dimensional rectangular housing. See FIGS. 3 and 4. Any one of the shelf portions 30 of the shell 100 is then pushed inward and upward, into the interior of the housing defined by the shell 100, to define a shelf. Because all the shelves 30′ of the insert are contiguous and formed from a single piece of material, deploying one shelf portion 30 of the shell 100 deploys all of the shelf portions 30. When this is done, tabs 31 and 33 of each shelf panels 30′ forms a friction fit with the interior surface of the shell 100. Bottom support panel 32 of the insert 200 is pulled upward and folds along fold line 19′ so that its bottom edge aligns flush with the bottom edge of the shell 100. With the bottom edge of the bottom support panel 32 now flush with the bottom edge of the shell 100, the inner bottom panel 18 and tabs 22 and 24 are folded inward along fold line 15, followed by outer bottom panel 20. Outer panel 20 has defined therein a tab 21, which fits into a cooperating slot 21′ defined in the lower edge of front panel 14, thereby forming a housing from the shell 100 with the insert attached to the rear panel 10. (The outer bottom panel 20 hinges back to front; the tab 21 and cooperating slot 21′ are thus located in the bottom edge of the front panel 14 of the shell.) Each retaining tab 28 is then pushed inward and downward, folding back upon the interior surface of the front panel 14. Thus, when the entire pop-up display is set on bottom panel 20, the bottom support panel 32 supports all of the shelves formed by one or more sets of corresponding/cooperating panels 30′ of the insert 200 and panels 31 of the shell 100.

1. A collapsible, pop-up display comprising:
an outer shell fabricated from a first single piece of sheet material having an inside surface and an outside surface, the outer shell comprising:
front and rear panels,
left and right panels,
at least one bottom panel, and
at least one pre-perforated aperture, convertible from a first, closed position and a second, open position, wherein in the first position, the aperture is covered by an integral, pre-perforated upper shelf portion and an integral, pre-perforated lower tab portion; and
an insert fabricated from a second single piece of sheet material, the insert comprising:
a front panel,
left and right panels,
a bottom support panel; and
at least one pre-perforated shelf panel, corresponding in number to the number of pre-perforated apertures in the shell, wherein the pre-perforated shelf panels in the insert are disposed in registration with the pre-perforated aperture(s) when the insert is disposed inside the shell;
wherein the inside surface of the shell, at the pre-perforated upper shelf portion, is fastened to the at least one shelf panel of the insert.

2. The collapsible, pop-up display of claim 1, wherein the shell and the insert are made from corrugated paper, cardboard, foam board, or chipboard.

3. The collapsible, pop-up display of claim 1, wherein the shell and the insert are made from corrugated paper.

4. The collapsible, pop-up display of claim 1, wherein the shell and the insert are made from cardboard.

5. The collapsible, pop-up display of claim 1, wherein the shell and the insert are made from foam chipboard.

6. The collapsible, pop-up display of claim 1, wherein the shell and the insert are made from chipboard.

7. The collapsible, pop-up display of claim 1, wherein the shell and the insert are fastened by glue.

8. The collapsible, pop-up display of claim 1, wherein the shell and the insert are fastened by hook-and-loop-type fasteners.

9. The collapsible, pop-up display of claim 1, wherein the shell and the insert are fastened by snaps.
